(19) United States
(12) Patent Application Publication
(10) Pub. No.: US 2008/0163376 A1
(43) Pub. Date: Jul. 3, 2008

(54) HARDWARE SECURITY MODULE, COMMISSIONING METHOD AND ELECTRONIC PAYMENT TERMINAL USING THIS MODULE

(75) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Compagnie Industrielle et Financiere D'Ingenierie "Ingenico", Neuilly Sur Seine (FR)

(21) Appl. No.: 11/967,475

(22) Filed: Dec. 31, 2007

(30) Foreign Application Priority Data
Jan. 2, 2007 (FR) 07/00002

(51) Int. Cl. G06F 21/00

(52) U.S. Cl. 726/26

(57) ABSTRACT

A hardware security module is provided, which includes: a memory able to store a secret; a processor coupled to the memory; a sealed chamber containing a gas; a transducer coupled to the processor, sensitive to a property of the gas, able to convert this property into a signal and to supply this signal to the processor. The processor is able to generate or accept a secret in the event of the reception of a signal, supplied by the transducer, corresponding to a first substantial variation in said property of the gas. The processor is able to act on the secret in the event of the reception of a signal, supplied by the transducer, corresponding to a second substantial variation in said property of the gas. A method is also provided for commissioning such a module as well as an electronic payment terminal including this module.

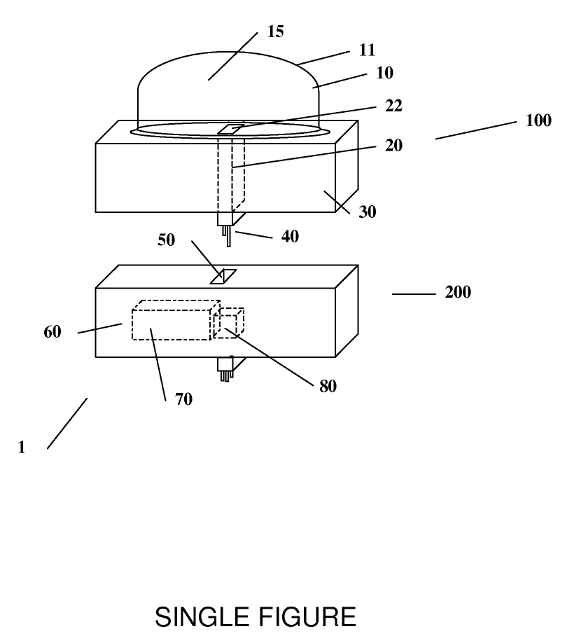

### CROSS-REFERENCE TO RELATED APPLICATIONS

None.

### FIELD OF THE DISCLOSURE

The present disclosure concerns a hardware security module, as well as a method of commissioning this module and an electronic payment terminal equipped with such a module.

### BACKGROUND OF THE DISCLOSURE

Various technologies for hardware security modules are known, also called HSMs (from the English “Hardware Security Modules”).

A security module is for example a PCI card (for example the IBM 4758 PCI card) or an SCSI/IP external device. Its role is to reliably store secrets, in the long term, for cryptographic usage and to protect (generally physically) access to and the use of the secrets over time. A security module may also be capable of generating this secret. Generally, the secrets are private keys, used in cryptography. Certain security modules also allow the hardware protection of symmetrical keys.

A security module may be able to be coupled to a host system stored by a data processing machine. This module may for example be sealed to the body of a machine and comprise elements essential for its functioning so that it is not possible to remove this module or put it out of service without interfering with the use of the machine.

These modules are generally in accordance with the FIPS (“Federal Information Protection Standard”) standard 140 (for example PUB 140-1 Level 3 or higher), which establishes safety requirements. For example, the FIPS 3 standard requires a security module to be inviolable within the meaning of both the English terminologies “tamper-evident” and “tamper-resistant”. Inviolability in the sense of tamper-evident is normally obtained by the use of a ring and a tamper-evident seal. Inviolability in the sense of tamper-resistance is normally obtained by coating the tips of cards in a non-conductive plastic resin.

Such security modules suffer various problems. The first problem is that the “resin” technology involves constraints on the shape of the circuit making up the module, which must be square. Another problem is related to thermal dissipation and to the stresses exerted by the resin on the circuit: the resin does not stretch like the support under the effect of temperature. This sometimes results in a not insignificant breakage rate during production or assembly (the rate may be as high as 15%). The security module can then not be reused.

There therefore exists a need for a security module guaranteeing inviolability, and resolving at least one of the above problems caused by the use of resin. In particular, this module must be of such a design that it does not cause constraints with regard to the shape of the circuit. Ideally, this module should be at least partially recyclable, more resistant to physical penetration and less expensive than a conventional resin module.

### SUMMARY

An aspect of the present disclosure relates to a hardware security module comprising a memory able to store a secret, a processor coupled to the memory, in which: the hardware security module also comprises: a sealed chamber comprising a gas, a transducer coupled to the processor, sensitive to a property of the gas, able to convert this property into a signal and supply this signal to the processor, in which the processor is able to generate or accept a secret in the event of reception of a signal, supplied by the transducer, corresponding to a first substantial variation in the said property of the gas; and the processor is able to act on the secret in the event of reception of a signal, supplied by the transducer, corresponding to a second substantial variation in said property of the gas.

In one example, the module comprises one or more of the following characteristics:
the module also comprises a chemical agent in the chamber, able to release a quantity of gas by ignition;
the transducer is a sensor sensitive to the pressure of the gas;
the processor also being able to: generate or accept a secret in the event of reception of a signal corresponding to a first substantial variation in pressure; and to act on the secret in the event of reception of a single corresponding to a second substantial variation in pressure, where applicable of opposite sign to the first variation;
the module also comprises a sensor sensitive to the temperature of the gas; and
the module comprises: a first part comprising the chamber, the transducer and the memory; and a second part, in which one of these parts can be plugged onto the other of these parts.

The disclosure also concerns an electronic payment terminal comprising a hardware security module according to the disclosure.

The disclosure also concerns a method of commissioning a hardware security module comprising the step of supplying the hardware security module and establishing the property of the gas in the chamber.

In an example, the method comprises one or more of the following characteristics:
the method also comprises a step of loading the secret into the memory of the hardware security module; and
the method comprises the steps of: supplying a batch of hardware security modules; and random modification in a given range of the property of a gas in the chambers of modules in the batch, the given range being distant from the threshold value.

Other characteristics and advantages will emerge from a reading of the following detailed description given solely by way of example and with reference to the single FIGURE, which shows a security module according to one example of the disclosure.

An aspect of the disclosure proposes a hardware security module comprising a memory able to store a secret and a processor coupled to the memory. This module also comprises a sealed chamber containing a gas and a transducer coupled to the processor. This transducer is sensitive to a property of the gas, for example the pressure; it is able to convert this property into a signal supplied to the processor. The processor is designed to act on the secret (for example to delete it) if the signal received indicates a physical violation of the chamber.

This module is designed so that a variation in a property of the gas occurs in the event of physical violation of the module. A violation of the module results for example by a violation of the chamber (fracture, etc.), which gives rise in particular to a change in pressure. The subsequent variation in property of the gas then generates a corresponding signal, which is interpreted by the processor, which then acts on the secret. For example, this variation in property leads to a threshold value, predefined accordingly, being passed (in one direction or the other). More specifically, this threshold value can be defined so that a physical violation certainly causes the threshold value to be passed. In a variant, it is a variation in pressure over time that is interpreted by the processor. In any event, the processor is able to act on the secret in the event of reception of a signal, supplied by the transducer, corresponding to a substantial change in the property of the gas.

Such a module therefore ensures inviolability in the sense of the English terminology tamper-resistance, without for all that requiring coating with non-conductive plastic resin. Its design involves no particular constraint with regard to the shape of the circuit (comprising the processor, the memory, etc.). Thus drawbacks related to the use of resin are avoided.

Transducer means a device that serves to convert, according for example to a given law, a physical quantity into another physical quantity or into another value of the same quantity, with a given precision. The transducer in question may for example be a pressure sensor; it may also be any other device for characterising a violation of the chamber.

### BRIEF DESCRIPTION OF THE DRAWINGS

The single FIGURE shows a security module according to one example of the disclosure.

### DETAILED DESCRIPTION OF ILLUSTRATIVE EMBODIMENTS

In more detail, this FIGURE shows a hardware security module 1 equipped with a memory 80 able to contain the secret. A processor 70 is coupled to the memory 80. The processor and memory may be of the same type as those equipping known security modules. The memory 80 may for example be a RAM memory maintained by a battery. As in known devices, the role of the processor 70 and memory 80 is to store this secret reliably, in the long term, for cryptographic use. The processor may also be capable of generating this secret, as will be described below. The secret in question may for example be a private key.

According to a non-limiting example, the security module shown also comprises a sealed chamber 10 in which a gas 15 is contained. In practice, this chamber may be formed by a casing 11 (or a tube) secured to a support 30. The design and manufacture of the casing 11 may be based on those of vacuum tube casings. The casing may be made from glass (for obtaining a relative vacuum in the chamber), but metal, molten quartz (silica) and ceramic are other possible choices. The thickness of the casing will vary according to resistance limits (mechanical, temperature, etc.) sought for the casing. Preferably also the casing is opaque, in order to prevent any interaction with a laser or other source of radiation.

In general, in the event of violation of the chamber, one property (at least) of the gas will change. For example, in the event of fracture of the chamber, the pressure of gas in the chamber changes. Typically, the chamber is charged with an inert gas at a pressure different from atmospheric pressure. Thus, in the event of violation (for example in the event of fracture), it is both the nature and pressure of the gas that change.

The security module may also comprise a transducer 20, 22 coupled to the processor 70. This transducer is sensitive to a property of the gas 15. It is in this regard disposed in the chamber in an appropriate manner: for example, the part 22 of the transducer that is sensitive to the property in question is directly exposed to the gas 15. In the example in the FIGURE, the part 22 fits flush with the surface of the support 30 to which the casing 11 closing the chamber 10 is fixed.

Typically, the transducer is a sensor sensitive to the pressure of the gas 15 in the chamber 10. The sensor in question comprises a mechanical member 22 that deforms under the action of the pressure of the gas 15 to be measured. The sensor 20, 22 produces an electrical signal, typically proportional to the pressure felt, this signal being intended to supply (indirectly) the processor 70. Other types of transducer can however be envisaged, for example a temperature sensor. The combination of several types of sensor can also be envisaged, as will be described below.

Whether it is a question of the pressure or another property of the gas, the transducer 20, 22 is able to convert this property into a signal, according to the principle of the transducer, and to supply this signal to the processor 70. The signal can be transmitted periodically or following a variation in the value measured. This depends on the nature of the transducer used.

The processor 70 coupled to the transducer is able to interpret the signal, which is equivalent to making it correspond to a given value or given range of values. For this purpose, the processor can compare the value conveyed by the signal with a reference value, stored in a memory, for example in the memory 70. Where applicable, a tolerance may be provided, in order to compensate for example for the fluctuations in pressure (due to a lack of seal, where applicable). More advanced operations may however be involved, such as comparison with a reference curve. This will be described below.

According to the result of this interpretation, the process can then take appropriate steps with a view to protecting the secret. In particular, the processor 70 is able to act on the secret contained in the memory, in the event of reception of a signal corresponding to a substantial variation in the property of the gas. This is for example the case when a gas property value passes a predefined threshold value. The processor can then for example directly delete or at least affect the secret so that it can no longer be violated.

According to an example described now, the action of the processor on the secret comprises two phases. The first of these phases corresponds to a commissioning phase while the second corresponds to a functioning phase aimed at preserving the secret.

In more detail, during the first phase (commissioning), a certain property is established for the gas 15 contained in the chamber.

This example may for example consist of mechanically loading an inert gas into the chamber. In a variant, mechanical means can be provided, deposited in the chamber, responsible for making the properties of the gas in the chamber change. These means may for example be dry ice that is to sublimate at atmospheric pressure to the gaseous state or molecules trapping a gas immediately loaded in the chamber. It may also be a case of pyrotechnic powder; this will be developed later.

A property of the gas—for example the pressure—is thus brought to a first value. Where applicable, this first value is situated beyond a first threshold value known or accessible to the processor 70. On reception of a signal corresponding to a substantial variation in the property of the gas, the processor generates the secret, which is then stored in the memory 80.

In a variant, the processor does not itself generate the secret but awaits reception of the secret, which is then loaded into the memory by means of a device external to the security module, in a manner known per se.

During a second phase, the processor 70 is able to act on the secret in the event of reception of a signal corresponding to a second variation, for example corresponding to a value of said property passing a second threshold value. The variations or passing of “threshold value” during the first and second phases may take place in the same direction or in opposite directions (that is to say in a first direction and then in the other, according to circumstances).

Where applicable, the processor 70 does not act on the secret in the event of passing of the second threshold value unless the first threshold value has already been passed.

By way of example, on commissioning, it is possible to charge the casing 11 with inert gas at a pressure higher than atmospheric pressure P0. When the current pressure P established in the chamber 11 passes a first threshold value P1 (that is to say it passes above P1, i.e. P>P1, for example P1=2P0), the processor 70 generates the secret or awaits reception of the secret. During the use phase, in the eventuality of the module being physically violated, the casing 11 is broken and the current pressure P drops to P0. In dropping, the current pressure passes the second threshold value P2 (P0<P2<P1), that is to say it passes this time below the second threshold value P2. On reception of the corresponding signal, the processor 70 acts on the secret as explained above.

In fact, the processor 70 acts on the secret when the pressure passes below P2 only because the pressure has already passed P1 on the first occasion. In this regard, the sign of the variation can be used by the processor in order to decide on the action to be taken.

P2 may be equal to P1, which requires storing only one reference value (plus a tolerance where necessary). In this case, the processor tests whether the threshold value has been passed twice in a row, in opposite directions. However, it is preferable to choose a pressure value P2<P1 in order to keep control of the state of the secret during manufacture (for a given pressure, it is known in a certain manner whether or not the processor has deleted a secret). Likewise, a value of P2 different from P0 is preferably chosen in order to keep control of the state of the secret during manipulations at ambient pressure.

According to a variant, the chamber 10 is brought to a pressure lower than atmospheric pressure P0 (negative pressure) during commissioning. The state of the negative pressure can be obtained in a similar fashion to a method of manufacturing an electronic tube or chemically. When the current pressure P passes below P1 (P<P1), with for example P1=P0/4, the processor generates the secret or awaits the secret. Next, in the event of violation, the current pressure P rises to P0 again. In rising, the current pressure passes a second threshold value P2 (P1<P2<P0), that is to say it passes this time above the second threshold value P2 (for example P1=3P0/8).

As illustrated above, distinct values for P2 and P1 are preferably chosen. In the light of the explanations supplied above, a person skilled in the art will realize that it is however possible to implement one or more of the examples described herein for a single value of P2=P1.

It may also be advantageous to provide a tolerance when it is tested whether P<P1, P<P2, P>P1 or P>P2, in order to prevent any inopportune action of the processor. The tolerance in question is adjusted according to the estimated conditions of use. For example, if these conditions involve a given local temperature, it is necessary to provide for an associated change in pressure and to reflect this change in the tolerance.

The processor can be designed to function on a single cycle, for certain applications. For example, if it detects that the values P1 and then P2 have both already been passed once, it is no longer able to generate or await a secret. For other applications and in particular with a view to its recycling it can be able to function on several cycles. For example, after a first cycle, if it detects that the value P1 is passed, the processor 70 is once again able to generate or await a secret.

In addition, the module 1 preferably comprises two parts 100, 200, as illustrated in the FIGURE. A first part 100 comprises the chamber 10, the transducer 20, 22, and the memory 80 keeping the secret, while the second part 200 consists of other components of the security module. One of these parts, for example the first part 100, can be plugged onto the other part 200. A standard pin connector can be used for example.

In this way, in the event of breakage or malfunctioning of the chamber or transducer, only the first part 100 is lost. The other components of the module (for example the processor) contained in the second part can be directly recycled by plugging them into a new chamber. The module is then partially recyclable, which is a considerable advantage compared with resin HSMs.

The module 1 preferably comprises a sensor sensitive to the temperature of the gas 15, apart from the transducer 20, 22. The combination of sensors sought is for example a pair of pressure and temperature sensors. This makes it possible to allocate the module 1 to varied conditions of use, with regard to the temperature. The comparison with threshold values can then take the form of a comparison with pairs of pressure/temperature values (hereinafter P, T). It may however prove to be more advantageous to compare the pair of current values P, T with a pressure/temperature curve of the gas 15, for example modelled in the form of a simple function, known to the processor 70. When the pairs P, T substantially deviate from the curve, then the processor 70 acts on the secret as described above.

According to another example, the module 1 is provided with a capsule comprising a chemical compound, for example gunpowder or an equivalent, for example a pyrotechnic material, and means of igniting this material. When the module is commissioned, it is connected in the factory to an electrical circuit that generates a spark by means of the ignition means. The ignition means are for example a circuit relaying a discharge, terminating in an electrode able to produce a spark. The release of gas that is used causes a substantial rise in pressure, for example to a value P1. The pressure then established is stored in a memory, for example the memory 70. If then, during the use phase, a pressure drop is detected, the processor acts on the secret as disclosed above. The expected cost price of such a module is currently around US$0.8.

According to a variant, the module is assembled in the factory in a pressurised environment where a pressure P1 prevails (P1>P0). It is this pressure that is consequently established in the chamber 10. If then, during the use phase, a pressure drop is detected, the processor acts on the secret.

In addition, in order to make the security modules 1 even more secure and to protect against a violation, the commissioning method may be modified so as to initially load the module chambers at random pressures. The pressures are however confined in a range sufficiently remote from the threshold value or values in order to prevent any inopportune action of the processor. Thus it is not possible to provide for a change in the pressure in a chamber when a given temperature is applied.

As mentioned above, the security module 1 can be able to be coupled to a host system stored by a data processing machine. In this regard, the security module can comprise an input/output module, coupled to the processor, responsible for data exchanges between the host system and the circuit via a PCI bus. The processor is typically provided with functionalities providing enciphering and deciphering operations as well as the storage of information in the memory. The security module can also be provided with various means for preventing the host system having access to certain information (in particular the secrets) stored in the memory. In one example, the processor, the input/output module and the access prevention means are arranged in the second part 200 visible in the FIGURE, with a view to possible recycling.

In this regard, the disclosure also concerns an electronic payment terminal, equipped with the security module 1 as described above.

An electronic payment terminal (EPT) is generally known in the art: it is an electronic appliance for recording a secure payment transaction. An EPT is typically a computer placed with a merchant, which allows payments by bank cards (such as chip cards or magnetic-track cards). The merchant introduces the card of his customer into the reader of the terminal and enters the amount of the transaction. The customer validates his purchase, for example by keying in his confidential code on the keypad of the appliance and receives a voucher confirming the transaction.

The inviolable security module 1 offers the cryptographic functions necessary for the protection of transactions by means of the EPT. It may for example support varied payment terminal systems, used throughout the entire world. The security module can for example integrate various key management schemes required for protecting the terminals, such as for example the “Racal Transaction Key” scheme, the Single and Triple DES versions of the DUKPT schemes (standing for “Derived Unique Key Per Transaction”) and “Australian Transaction Key”.

The disclosure is however not limited to the variants described above but is capable of many other variations easily accessible to a person skilled in the art. For example, the transducer can be a chemical sensor (such as a gas composition sensor). Such sensors are known from the art for example. Such a sensor can for example consist of a chemoselective part (that is to say allowing the recognition of the chemical species) and a detector that translates the chemical interaction into an electrical signal. Rather than basing the action of the processor on the detection of a pressure difference, the action is then based on the detection of a change in the chemical composition of the gas 15 in the chamber.

By way of example again, rather than deleting the secret, the processor may supply an alert signal or encipher the secret by means of a public key known only to the legitimate proprietor of the device. A time delay can also be provided before the deletion of the secret.

Although the present disclosure has been described with reference to one or more examples, workers skilled in the art will recognize that changes may be made in form and detail without departing from the scope of the disclosure and/or the appended claims.

What is claimed is:

1. Hardware security module comprising:
a memory able to store a secret;
a processor coupled to the memory;
a sealed chamber comprising a gas;
a transducer coupled to the processor, sensitive to a property of the gas, able to convert this property into a signal and to supply this signal to the processor;
in which:
the processor is able to generate or accept a secret in the event of the reception of a signal, supplied by the transducer, corresponding to a first substantial variation in said property of the gas;
the processor is able to act on the secret in the event of the reception of a signal, supplied by the transducer, corresponding to a second substantial variation in said property of the gas.

2. Hardware security module according to claim 1, wherein:
the module also comprises a chemical agent in the chamber, able to release a quantity of gas by ignition.

3. Hardware security module according to claim 1, wherein:
the transducer comprises a sensor sensitive to pressure of the gas.

4. Hardware security module according to claim 1, wherein the processor is also able to:
generate or accept a secret in the event of the reception of a signal corresponding to a first substantial variation in pressure; and
act on the secret in the event of the reception of a signal corresponding to a second substantial variation in pressure, where applicable of opposite sign to the first variation.

5. Hardware security module according to claim 1, wherein the module also comprises a sensor sensitive to the temperature of the gas.

6. Hardware security module according to claim 1, wherein the module comprises:
a first part comprising the chamber, the transducer, and the memory; and
a second part,
in which one of these parts can be plugged onto the other of these parts.

7. Electronic payment terminal comprising a hardware security module according to claim 1.

8. Method of commissioning a hardware security module, comprising:
supplying the hardware security module, which comprises:
a memory able to store a secret;
a processor coupled to the memory;
a sealed chamber comprising a gas; and
a transducer coupled to the processor, sensitive to a property of the gas, able to convert this property into a signal and to supply this signal to the processor, in which:
the processor is able to generate or accept a secret in the event of the reception of a signal, supplied by the transducer, corresponding to a first substantial variation in said property of the gas; and
the processor is able to act on the secret in the event of the reception of a signal, supplied by the transducer, corresponding to a second substantial variation in said property of the gas; and
establishing the property of the gas in the chamber.

9. Method according to claim 8, wherein the method also comprises:
loading the secret into the memory of the hardware security module.

10. Method of commissioning a batch of hardware security modules, comprising:
supplying the batch of hardware security modules, wherein each module comprises:
a memory able to store a secret;
a processor coupled to the memory;
a sealed chamber comprising a gas; and
a transducer coupled to the processor, sensitive to a property of the gas, able to convert this property into a signal and to supply this signal to the processor, in which:
the processor is able to generate or accept a secret in the event of the reception of a signal, supplied by the transducer, corresponding to a first substantial variation in said property of the gas; and
the processor is able to act on the secret in the event of the reception of a signal, supplied by the transducer, corresponding to a second substantial variation in said property of the gas; and
randomly modifying in a given range the property of a gas in the chambers of modules in the batch, the given range being distant from a threshold value with which at least one of the first or second substantial variations are compared.
